(19) United States
(12) Patent Application Publication
(10) Pub. No.: US 2012/0086957 A1
(43) Pub. Date: Apr. 12, 2012

(54) RECORDING APPARATUS

(75) Inventors: Masashi Hayashi, Yokohama-shi (JP); Jiro Moriyama, Kawasaki-shi (JP)

(73) Assignee: CANON KABUSHIKI KAISHA, Tokyo (JP)

(21) Appl. No.: 13/241,027

(22) Filed: Sep. 22, 2011

(30) Foreign Application Priority Data
Oct. 6, 2010 (JP) 2010-226584

(51) Int. Cl. G06K 15/02; B41J 2/155

(52) U.S. Cl. 358/1.5; 347/42

(57) ABSTRACT

A recording apparatus includes a direct sensor arranged so as to face a second surface of a moving sheet on the back side of a first surface thereof and configured to perform measurement on the second surface at a measurement position to thereby detect at least one of information on sheet inclination at the measurement position and positional information on a sheet position in the direction of the distance between a recording head and the sheet at the measurement position. A control unit controls the operation of the recording apparatus based on the detection by the direct sensor.

### BACKGROUND OF THE INVENTION

1. Field of the Invention

The present invention relates to a recording apparatus configured to record an image on a sheet by a recording head by using a sensor for measuring the sheet condition.

2. Description of the Related Art

Regarding an inkjet recording apparatus, there is known a technique according to which the inclination angle of a sheet is detected in the vicinity of a recording head to control the ink discharge timing so that an image may be recorded at the correct position. Japanese Patent Application Laid-Open No. 2007-276264 discusses an apparatus in which distance detection sensors are provided at two positions (on the upstream side and the downstream side in the sheet conveyance direction) on the lower surface of a carriage reciprocating with a recording head mounted thereon. Each sensor measures the distance to the surface of a sheet (the surface on which an image is recorded), whereby it is possible to detect a local inclination angle of the sheet with respect to the conveyance direction and fluctuations in the distance.

In the apparatus discussed in Japanese Patent Application Laid-Open No. 2007-276264, both of the two sensors, which are provided on the movable carriage, are not always situated right above the sheet. For example, when the carriage, which reciprocates, has moved outwards beyond the sheet, the sensors are deviated from the positions right above the sheet, so that measurement is impossible.

The smaller the size (width) of the sheet used, the higher the frequency of the carriage being deviated from its position right above the sheet. Before the leading edge of the sheet guided to its position under the recording head has reached the downstream side sensor, detection is only possible for the upstream side sensor, so that it is impossible to obtain the inclination angle. On the other hand, it is also impossible to detect the inclination angle when recording has progressed and the trailing edge of the sheet has left the upstream side sensor.

That is, in the apparatus of the construction as discussed in Japanese Patent Application Laid-Open No. 2007-276264, it is only possible to perform measurement when both sensors are right above the sheet, and otherwise, measurement is impossible, which means a substantial restriction in terms of usability.

### SUMMARY OF THE INVENTION

The present invention is directed to a recording apparatus capable of detecting a sheet condition without being influenced by a moving condition of a carriage and a position, size, etc. of the sheet, and recording an image of high quality.

According to an aspect of the present invention, a recording apparatus includes: a recording head configured to record an image on a first surface of a moving sheet; a sensor arranged so as to face a second surface of the moving sheet on the back side of the first surface thereof and configured to perform measurement on the second surface at a measurement position to thereby detect at least one of information on sheet inclination at the measurement position and positional information on a sheet position in the direction of the distance between the recording head and the sheet at the measurement position; and a control unit configured to control apparatus operation based on the detection by the sensor.

In a recording apparatus according to the present invention, it is possible to detect the sheet condition by using a direct sensor provided on the second surface side of the sheet without being influenced by the carriage moving condition and the position, size, etc. of the sheet. Various apparatus operations are controlled based on the detection result by this direct sensor, so that it is possible to record an image of high quality.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A to 1C each illustrate positional relationship between a recording head and a sheet in a serial printer.

FIGS. 2A to 2F illustrate ink impact positions in the examples illustrated in FIGS. 1A to 1C.

FIGS. 3A to 3C each illustrate positional relationship between the recording head and the sheet in a line printer.

FIGS. 4A to 4F illustrate ink impact positions in the examples illustrated in FIGS. 3A to 3C.

FIGS. 5A and 5B are schematic diagrams illustrating a configuration of a serial printer according to an exemplary embodiment.

FIGS. 6A and 6B are schematic diagrams illustrating a configuration of a line printer according to an exemplary embodiment.

FIGS. 7A and 7B are diagrams illustrating the inner configuration of a direct sensor.

FIG. 8 is a flowchart illustrating a detection sequence in a printer.

FIG. 9 is a diagram illustrating an example of a shape of the sheet in the vicinity of a recording unit.

FIG. 10 is a diagram illustrating an example of the shape of the sheet in the vicinity of the recording unit.

FIGS. 11A and 11B illustrate examples of a data table.

FIGS. 12A to 12C are flowcharts illustrating detection sequences performed by a direct sensor.

FIGS. 13A and 13B are flowcharts illustrating detection sequences performed by a direct sensor.

FIGS. 14A and 14B are flowcharts illustrating detection sequences performed by a direct sensor.

### DESCRIPTION OF THE EMBODIMENTS

Various exemplary embodiments, features, and aspects of the invention will be described in detail below with reference to the drawings.

Prior to the description of exemplary embodiments of the present invention, the idea on which the invention is based will be described. First, the behavior of a recording apparatus when the posture and distance of the sheet with respect to the recording head are changed will be described.

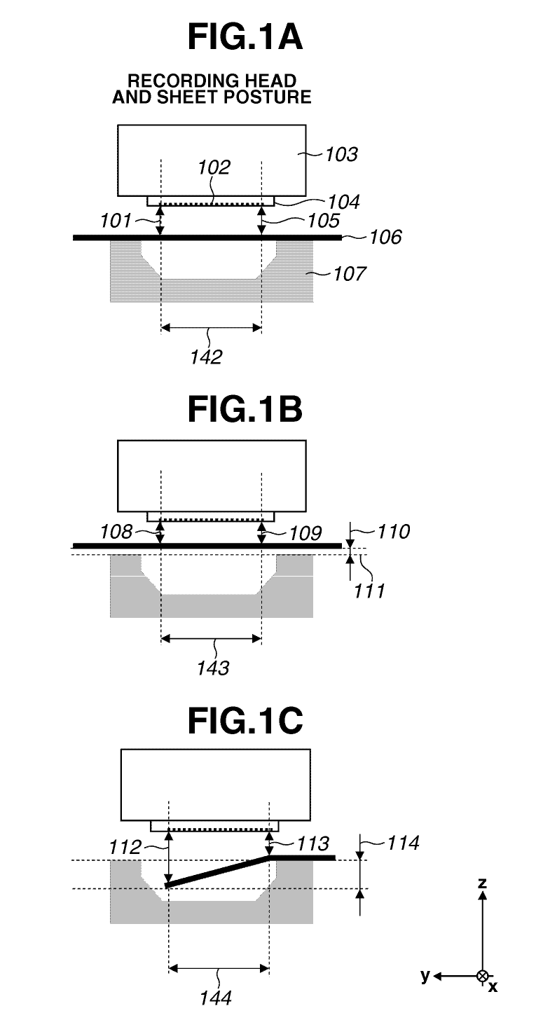

FIGS. 1A to 1C illustrate some of the forms of the positional relationship between the recording head and the sheet in a serial printer. The serial printer has a carriage configured to reciprocate, with a recording head mounted thereon, in a direction crossing the direction in which the sheet is moved, forming an image through alternate repetition of step movement of the sheet and movement of the carriage.

FIG. 1A illustrates an ideal state. A nozzle formation surface of a recording head 104 mounted on a carriage 103 is parallel to the surface of a sheet 106 supported by a platen 107. That is, the distance between the recording head 104 and the sheet 106 as measured in the gap direction (z-direction) is constant at all positions. In other words, the distance 105 as measured at the most upstream nozzle position in the y-direction (sheet conveyance direction), the distance 101 as measured at the most downstream nozzle position, and the distance as measured at a position between them, are all constant.

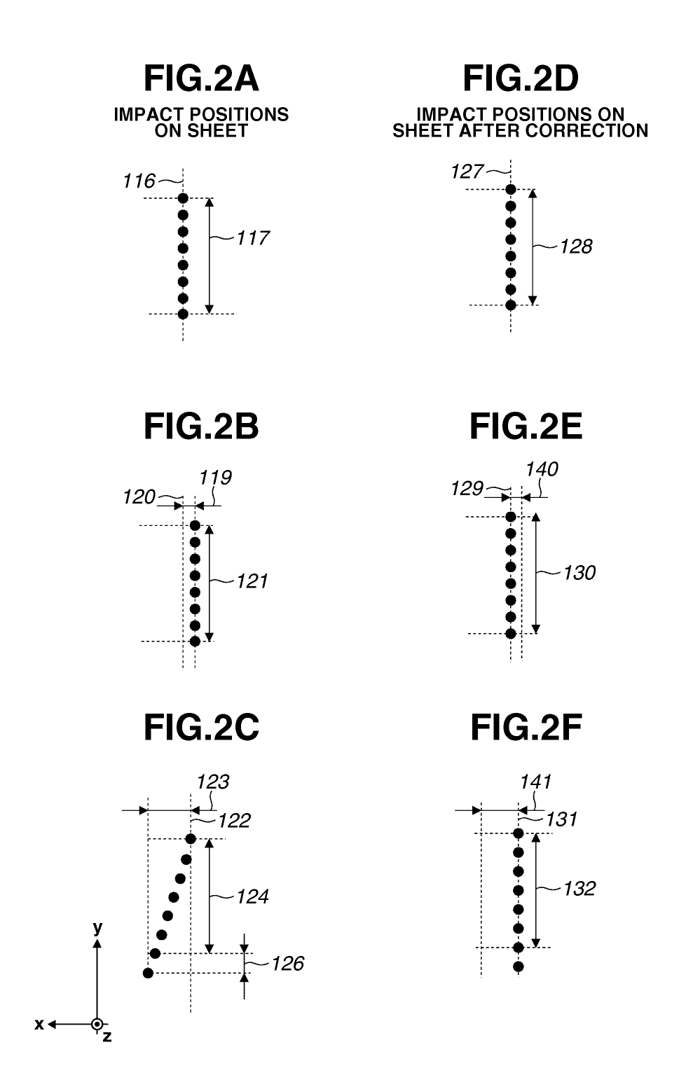

FIG. 2A illustrates ink impact positions on the sheet surface at a certain moment during scanning when image formation is conducted by discharging ink while performing scanning with the recording head 104 in the +x direction in the ideal state as illustrated in FIG. 1A. Ink droplets discharged from all nozzles 102 impinge upon a linear target position 116 (ideal position) on the sheet. The ink discharged from the nozzles 102 impinges upon the sheet within a target range 117 in the y-direction. The length of the target range 117 is equal to the length of a range 142 of the nozzles 102 in FIG. 1A. In this way, in the ideal state, the ink is imparted to an ideal position, so that there is no need to perform correction, and the condition of FIG. 2D (the ink as actually imparted) is completely the same as the condition of FIG. 2A.

FIG. 1B illustrates a state in which there has been a change in the distance between the recording head 104 and the sheet 106 while keeping them parallel to each other. The sheet 106 has risen from a platen 107, and the surface of the sheet has become closer to the nozzle formation surface of the recording head 104 by a distance 110 as compared with the ideal state of FIG. 1A. The distance 109 between them as measured at the most upstream nozzle position and the distance 108 between them as measured at the most downstream nozzle position are equal to each other.

FIG. 2B illustrates ink impact positions on the sheet surface at a certain moment during scanning when image formation is performed in the state of FIG. 1B. Each of the ink droplets impinges upon the sheet at a position deviated from a target position 120 to the −x side by a certain distance 119.

The reason for this is that the nearer the sheet to the recording head, the shorter the flying time of the ink droplets discharged from the nozzles. The ink droplets discharged from the nozzles impinge upon the sheet within a target range 121 (of the same length as the target range 117) in the y-direction. The target range 121 is of the same length as the range 143 of the nozzles 102 illustrated in FIG. 1B.

Such deviation of the impact position from the target position (ideal position) in the x-direction will lead to deterioration in image quality such as distortion or color drift. Thus, it is necessary to effect correction in the +x-direction by a distance 140 (=the distance 119) by some method so that the ink may be imparted to the proper position as illustrated in FIG. 2E. A specific method of correction will be described below.

FIG. 1C illustrates the sheet 106 inclined with respect to the recording head 104. An end portion of the sheet 106 is deflected in the −z-direction, and the distance between the recording head 104 and the sheet 106 in the gap direction (z-direction) gradually increases from a distance 113 at the most upstream nozzle position to a distance 112 at the most downstream nozzle position (the distance 112> the distance 113), which means the distance is not constant.

Such a state is apt to be generated in the region of the leading edge or the region of the trailing edge of the sheet being conveyed. In some cases, it is generated due to curling or cockling of the sheet. The direction in which the sheet is deflected is not limited to the −z-direction, and there are cases in which a sheet end portion is warped upwards or in which a part of the sheet is locally deflected in the z-direction.

FIG. 2C illustrates ink impact positions on the sheet surface at a certain moment during scanning when image formation is performed in the state of FIG. 1C. The ink impinges upon the sheet at a position deviated in the +x-side with respect to the target direction 122. The deviation in the +x-direction gradually increases from the upstream side toward the downstream side in the y-direction, the maximum deviation amount being the distance 123.

The reason for this is that the flying time of the ink discharged from the nozzles increases by an amount corresponding to the movement of the sheet away from the recording head. The more downstream in the y-direction, the longer the flying time, so that the deviation in impact position increases.

Further, also in the y-direction, the ink impact range is wider than the target range 124 (of the same length as the target range 117) by a deviation width 126. That is, the more downstream in the y-direction, the larger the deviation in the impact position in the y-direction.

The reason for this is that when the sheet is inclined, the length of the nozzle formation surface of the recording head (the distance 144 in FIG. 1C) is smaller than the actual length of the sheet of the corresponding region. The larger the inclination angle of the sheet, the larger the distance 123 of the maximum deviation amount in the x-direction and the deviation width 126.

In this way, deviation of the impact position from the target position (ideal position) in the x-direction and the y-direction causes deterioration such as distortion and color drift in the formed image. In view of this, it is necessary to perform correction by some method in the x-direction and the y-direction so that the ink may be imparted at the proper position 131 and in the proper width 132. A specific correction method will be described below.

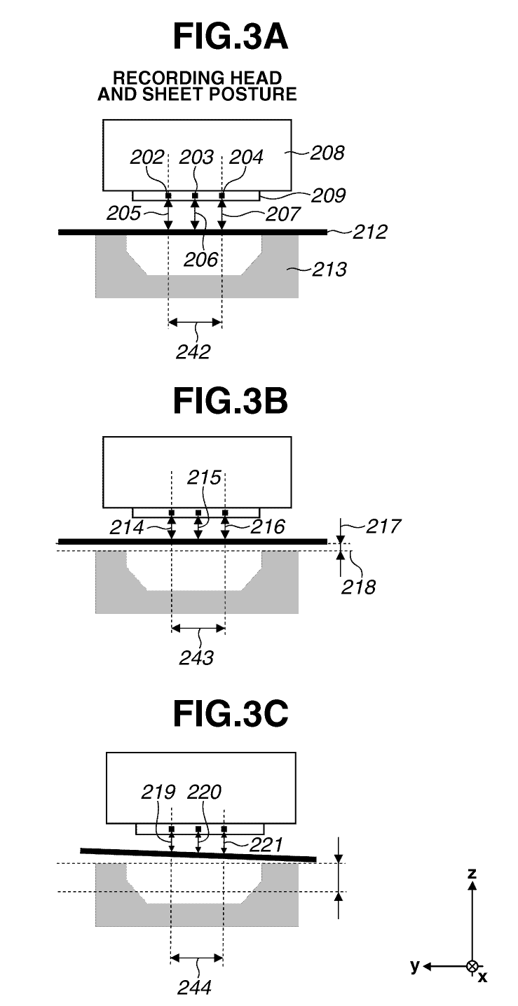

Such a problem is not involved not only in a serial printer but also in a line printer. FIGS. 3A and 3C illustrate some forms of the positional relationship between the recording head and the sheet in a line printer. A line printer also uses a line type head in which recording elements are formed along a direction crossing the direction in which the sheet moves, and forms an image by performing recording by a recording head while moving the sheet.

FIG. 3A illustrates an ideal state. A plurality of line heads 202, 203, and 204 are formed on the nozzle formation surface of a recording head 209 mounted on a stationary portion 208. To simplify the description, the number of line heads are three in this example, however, the number of line heads may be larger than this (e.g., seven).

On each line head, nozzles are formed along the x-direction within a range covering the width of the sheet to be used. The line heads 202 and 204 are spaced apart from each other by a distance 242.

In the ideal state, the nozzle formation surface of the recording head 209 and the surface of the sheet 212 supported by a platen 213 are parallel to each other. In other words, the distance between the recording head 209 and the sheet 212 in the gap direction (z-direction) is constant at all positions. In other words, the distance 205 at the position of the line head 202, the distance 206 at the position of the lie head 203, and the distance 207 at the position of the line head 204 are all constant.

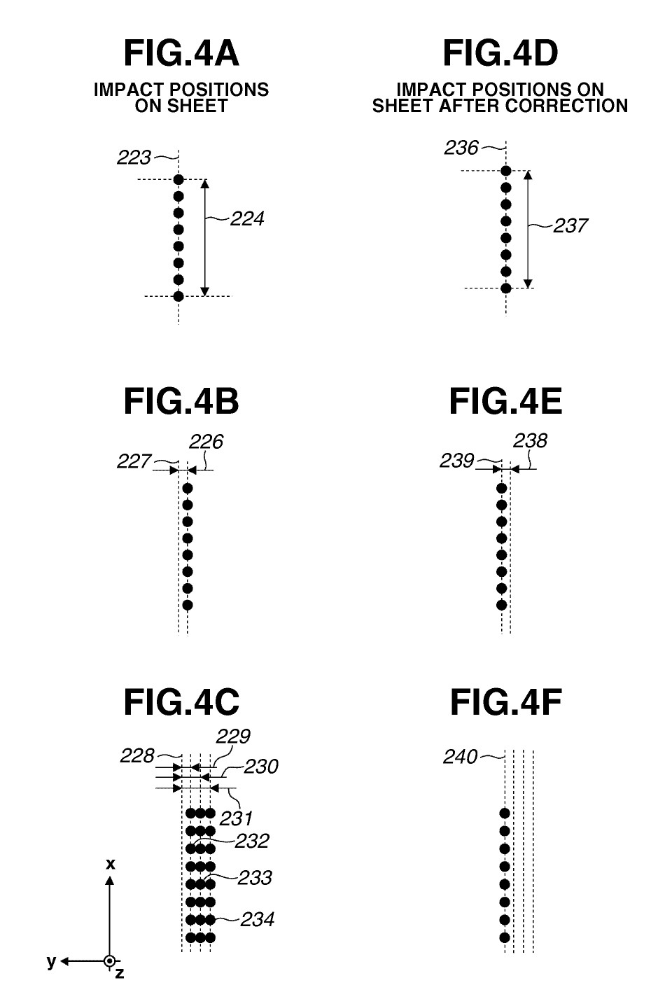

FIG. 4A illustrates the ink impact positions on the sheet surface at a certain moment when image formation is performed through ink discharge using one of the line heads 202, 203, and 204 in the ideal state of FIG. 3A.

The ink droplets discharged from all the nozzles impinge upon the sheet at a linear target position 223 (ideal position). The target range 224 in the y-direction is of the same length as the nozzle formation range of each line head in FIG. 3A. In this way, in the ideal state, ink is imparted at the ideal position, so that there is no need to perform correction, and FIG. 4D (the ink actually imparted) is completely the same as FIG. 4A.

FIG. 3B illustrates a state in which there has been a change in distance with sheet 212 being kept parallel with respect to the recording head 209. In this state, the sheet 212 has risen from the platen 213, and the surface of the sheet is closer to the nozzle formation surface of the recording head 104 by a distance 217 compared with the ideal state of FIG. 3A. The distances 214, 215, and 216 at the line head positions are equal to each other.

FIG. 4B illustrates the ink impact positions on the sheet surface at a certain moment when image formation is performed in the state of FIG. 3B. The ink impinges upon the sheet so as to be deviated from the target position 227 by a certain distance 226 on the −y side.

The reason for this is that the flying time of the ink droplet discharged from the nozzles is shorter by an amount corresponding to the distance by which the sheet has become closer to the recording head. In this way, when the impact position is deviated from the target position (ideal position) in the x-direction, deterioration is caused in image quality such as distortion or color drift.

In view of this, it is necessary to perform correction by a distance 238 (=the distance 226) in the +y-direction so that the ink may be imparted at the proper position 239 as in FIG. 4E. A specific correction method will be described below.

FIG. 3C illustrates a state in which the sheet 212 has been inclined with respect to the recording head 209. the distance between the recording head and the sheet in the gap direction (z-direction) gradually increases from the distance 219 at the position of the line head 202 to the distance 220 at the position of the line head 203, and then to the distance 221 at the position of the line head 204, which means the distance is not constant. That is, the following relationship holds true:

the distance 219<the distance 220<the distance 221.

FIG. 4C illustrates the ink impact positions on the sheet surface at a certain moment when image formation is performed in the state of FIG. 3C.

The ink impinges upon the sheet at a position deviated from the target position 228 on the −y side. The line head 202 corresponds to the position 234, the line head 203 corresponds to the position 233, and the line head 204 corresponds to the position 232. The distance from the target position 228 is a distance 229 at the position 232, a distance 230 at the position 233, and a distance 231 at the position 234 (the distance 229< the distance 230<the distance 231). The reason for this is that the closer the sheet to the recording head, the shorter the flying time of the ink discharged from the nozzles.

When the impact position is thus deviated from the target position (ideal position) in the y-direction, deterioration is caused in image quality such as image distortion or color drift. In view of this, it is necessary to perform correction in the +y-direction by some method so that the ink may be imparted at the proper position 240 as in FIG. 4F. A specific correction method will be illustrated below.

An exemplary embodiment of the present invention will be described. The application range of the present invention widely covers the field of movement detection where movement while controlling the movement and attitude of an object with high accuracy is required as in the case of a printer. For example, the present invention is applicable to apparatuses such as a printer and a scanner, and to apparatuses for use in the technical, industrial, and physical distribution fields where objects are conveyed and subjected to various processing such as inspection, reading, machining, and marking.

In the present exemplary embodiment, the term “sheet” means a sheet-like or plate-like medium formed of paper, plastic sheet, film, glass, ceramic, resin, etc. In the present exemplary embodiment, the terms “upstream and downstream” mean sides as seen in the moving direction of a sheet when performing image recording on the sheet.

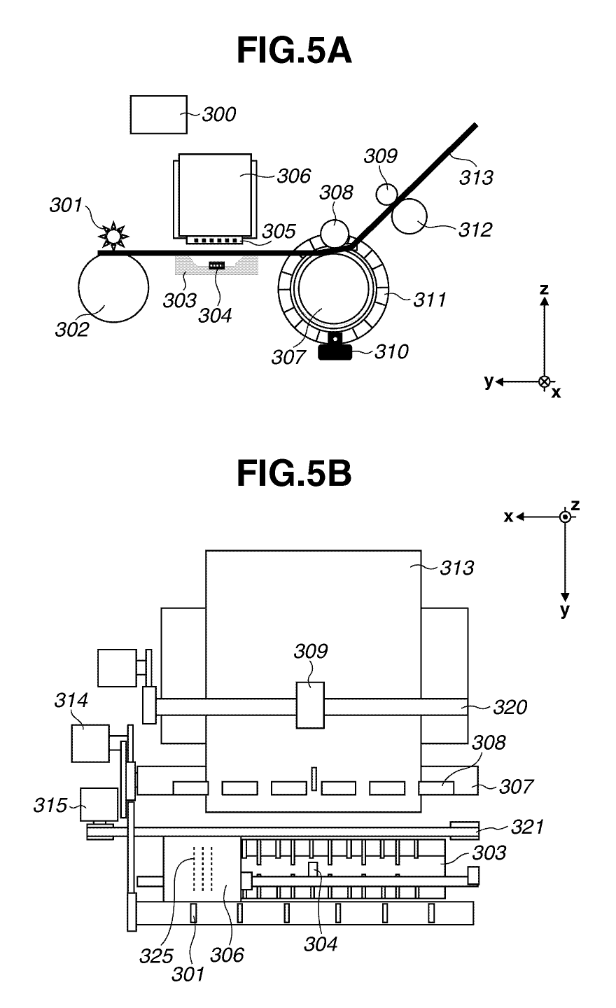

In the following, an inkjet type printer as an example of the recording apparatus, will be described. FIGS. 5A and 5B are diagrams illustrating the configuration of a principal portion of a serial print type printer, of which FIG. 5A is a sectional view of the same as seen from a side, and FIG. 5B is a top view of the same as seen from above.

The apparatus is equipped with sheet conveyance mechanism moving a sheet stepwise in the y-direction (first direction), and a recording unit configured to perform recording on the sheet band by band while reciprocating a recording head in the x-direction (second direction), which crosses the y-direction in the sheet plane.

Further, there is provided a control unit 300 configured to control the apparatus as a whole. The control unit 300 is not limited to one contained in the printer, and it may also be a host computer connected to the printer. The sheet to be used may be a cut sheet or a continuous sheet.

The sheet conveyance mechanism includes a feed roller consisting of a driving roller 312 and a driven roller 309, a conveyance roller consisting of a driving roller 307 and a driven roller 308, and a discharge roller consisting of a driving roller 302 and a spur 301. The driving roller 312 of the feed roller rotates with a shaft 320. The driving roller 307 of the conveyance rollers and the driving roller 302 of the discharge roller rotates using a motor 314 as a common drive source.

In the vicinity of the recording unit, a sheet 313 is conveyed in the y-direction (to the left as seen in FIG. 5A) by these rollers. The driving roller 307 serving as a main roller for conveying the sheet is equipped with a rotary encoder configured to indirectly acquire information on the moving condition of the sheet 313 by detecting the rotating condition of the roller. The rotary encoder has rotating encoder slits 311 and a detector 310 for detecting the slits.

The recording unit has a carriage 306 configured to reciprocate in the x-direction, and a recording head 305 mounted thereon. The recording head 305 has recording elements (ink nozzles) configured to discharge ink by an inkjet system, which may be a system using heat generation elements, a system using piezoelectric elements, a system using static electric elements, or a system using micro electro mechanical systems (MEMS) elements.

In the recording head 305, there are arranged in the x-direction a plurality of nozzle rows 325 in each of which a plurality of ink nozzles are formed in the y-direction over a length corresponding to 1-band width. The carriage 306 is caused to move in a straight line by a transmission mechanism including a driving belt 321 and a pulley, using a motor 315 as the drive source.

In synchronization with the movement of the carriage 306, ink is discharged from the nozzles of the recording head 305 to form. a 1-band image on the sheet 313. Further, a 1-band image is formed by the sheet conveyance mechanism. Through control by the control unit 300, the stepwise movement of the sheet by the sheet conveyance mechanism and the movement of the carriage 306 are alternately repeated to thereby form a two-dimensional image.

Provided below the carriage 306 is the platen 303 supporting the moving sheet from below. A recess (dent) is formed in the platen 303 at a position corresponding to the recording position where recording is performed by the recording head 305.

Provided in this recess is a direct sensor 304 directly performing optical measurement in a non-contact manner on a second surface of the sheet that is on the back side of the first surface on which the image is formed. The direct sensor 304 is provided at a position in the vicinity of the center of the recording region in the x-direction where it is possible to perform recording by the recording head 305 through reciprocal movement of the carriage 306.

The provision of the platen 303 is not indispensable, and it is also possible to employ a configuration in which ink is imparted by the recording head, with the sheet being kept in the air while held between the upstream and downstream roller pairs.

Based on the measurement performed on the sheet moving above the direct sensor 304, the direct sensor 304 can acquire a plurality of items of information such as the sheet moving condition, the sheet inclination information, and information on the sheet position in the direction of the distance between the recording head and the sheet. Based on the detection by the direct sensor 304, the control unit 300 controls the operation of various devices as described below.

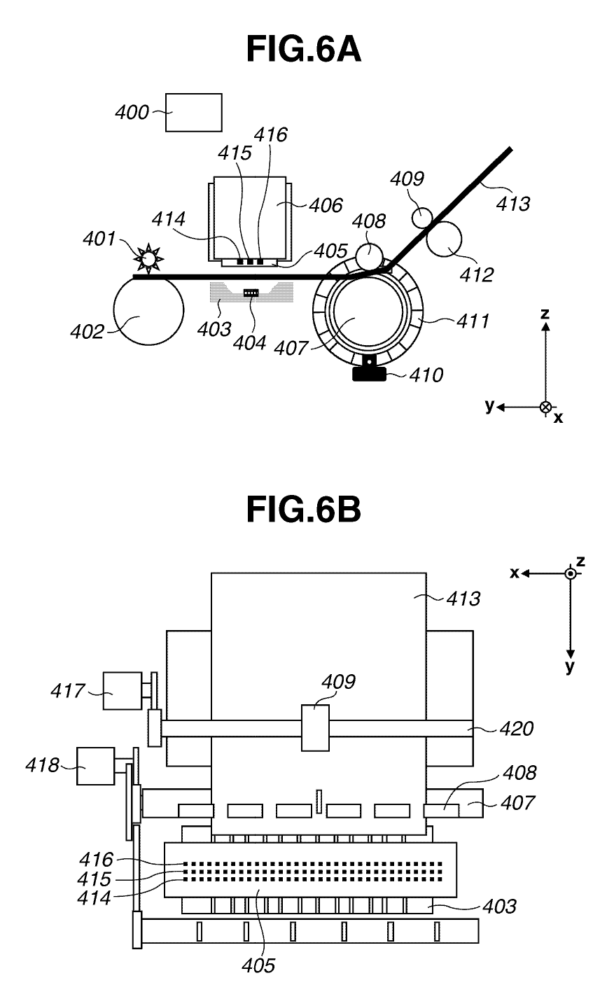

FIGS. 6A and 6B are sectional views illustrating a configuration of a principal portion of a line print type printer as another example of the recording apparatus. FIG. 6A is a sectional view of the portion as seen from a side, and FIG. 6B is a top view of the same as seen from above.

The apparatus is equipped with a sheet conveyance mechanism continuously moving the sheet in the y-direction (first direction), and a recording unit provided with a plurality of recording heads on which there are formed recording elements (ink nozzles) over a range including the width of the sheet used in the x-direction (second direction). Further, there is provided a control unit 400 configured to control the apparatus as a whole.

The control unit 400 is not limited to one contained in the printer but may also be a host computer connected to the printer. The sheet to be used may be a cut sheet or a continuous sheet.

The sheet conveyance mechanism has a feed roller consisting of a driving roller 412 and a driven roller 409, a conveyance roller consisting of a driving roller 407 and a driven roller 408, and a discharge roller consisting of a driving roller 402 and a spur 401.

The driving roller 412 of the feed roller rotates with a shaft 420, using a motor 417 as a drive source. The driving roller 407 of the conveyance roller and the driving roller 402 of the discharge roller rotates using a motor 418 as a common drive source.

In the vicinity of the recording unit, the sheet 413 is conveyed in the y-direction (to the left as seen in FIG. 6A) by these rollers. Similar to the case of FIGS. 5A and 5B, the driving roller 407 is provided with a rotary encoder having encoder slits 411 and a detector 410.

The recording unit has a recording head 405 on which there are formed a plurality of line heads 414, 415, and 416 respectively corresponding to different colors. While in this example the number of line heads is three for the sake of simplification of the description, the number of line heads may be larger than this (e.g., seven).

The recording head 405 is fixed to a stationary portion 406. On each line head, a large number of ink nozzles for discharging ink droplets by an inkjet system are formed in the x-direction in a linear or a staggered pattern over a range covering the maximum width of the sheet to be used.

Through control by the control unit 400, ink is discharged from the line heads 414, 415, and 416 in synchronization with the sheet conveyance (continuous feed) by the sheet conveyance mechanism, thereby forming a two-dimensional image on the sheet 413.

Below the recording head 405, there is provided a platen 403 for supporting the moving sheet from below. The platen 403 has a recess at a position corresponding to the recording position where recording is performed by the recording head 405.

Provided in the recess is a direct sensor 404 configured to directly perform optical measurement on the back surface (second surface) of the sheet in a non-contact fashion. The construction and function of the direct sensor 404 are the same as those of the direct sensor 304 illustrated in FIGS. 5A and 5B. The direct sensor 404 is provided at a position in the vicinity of the center of the recording region where recording is performed in the x-direction by the line head.

The provision of the platen 403 is not indispensable, and it is also possible to adopt a configuration in which ink is imparted by the recording head to a sheet, with the sheet being kept in the air while held between the upstream and downstream roller pairs. Based on the detection by the direct sensor 404, the control unit 400 controls various apparatus operations as described below.

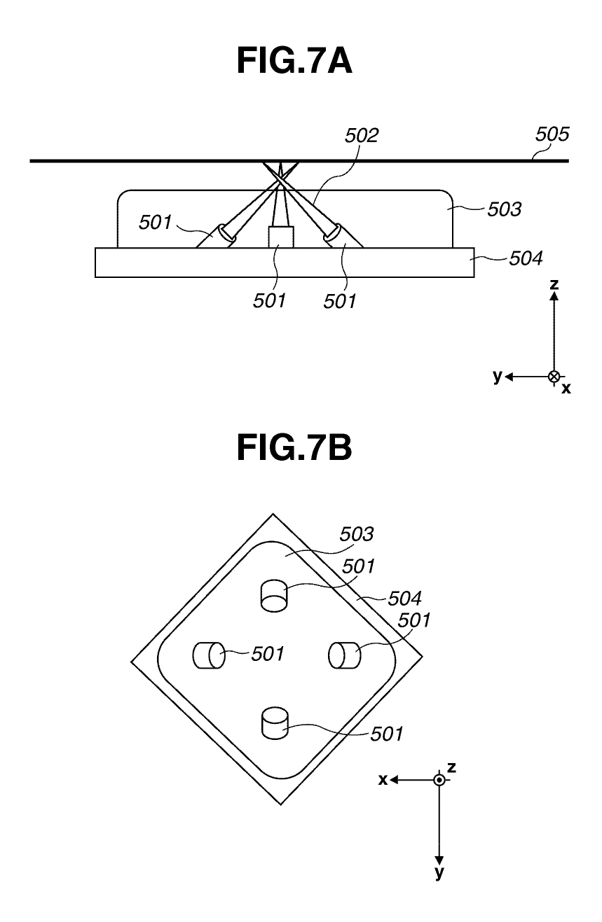

FIGS. 7A and 7B are diagrams illustrating the inner configuration of the direct sensor 304 and the direct sensor 404. FIG. 7A is a cross-sectional view, and FIG. 7B is a top view. The direct sensor of this example has a plurality of light sources and light receiving elements, and light from the plurality of light sources is emitted to the second surface of the sheet from different directions, and scattered light is received by the plurality of light receiving elements.

On a substrate 504, there are provided a plurality of (four in this example) modules 501 each integrally having one light source (a light source emitting coherent light such as a laser light source or an LED) and one light receiving element (a photoelectric conversion element such as a photo diode or an image sensor). A case 503 is bonded to the upper side of the substrate 504 so as to cover a plurality of modules 501. Near the center of the head portion of the case 503, there is formed a window through which light can pass.

Each of the four modules 501 irradiate a measurement position on the second surface of the sheet 505 at a predetermined angle with irradiation light 502. Irradiation light, which is coherent light, from the light source contained in a module 501 is scattered at the second surface of the sheet and is returned in the direction of the same module 501. Then, the irradiation light and the scattered light interfere with each other, and the intensity of the interference light is detected by the light receiving element contained in the same module 501.

When the sheet 505 is moved during measurement, a frequency shift is generated in the scattered light due to the Doppler effect according to the moving direction and the moving speed. At the detection position of the light receiving element where the irradiation light and the scattered light interfere with each other, the light intensity changes. By detecting this change in light intensity, it is possible to obtain information on the moving speed of the sheet.

Since the four modules 501 emit irradiation light to a sheet from different directions, it is possible to separately obtain sheet moving speed components in different directions (first direction and second direction).

Further, by using the output of the plurality of modules 501, the direct sensor can obtain information on local inclination of the sheet at the measurement position where the irradiation light is emitted (inclination angle with respect to an xy-plane, which includes the x-direction and the y-direction). Further, by using the output of the plurality of modules 501, the direct sensor can obtain sheet position information in the direction of the distance between the recording head and the sheet (z-direction) at the measurement position.

When the sheet is inclined, the balance of the detection signals of each of the four modules is changed, so that it is possible to obtain information on the inclination direction and the inclination angle. When the distance from the sensor to the sheet is changed, the respective detection signals of the four modules are accordingly changed, so that it is possible to obtain sheet position information in the distance direction.

The direct sensor is arranged so as to face the second surface on the back side of the first surface of the moving sheet where the image is recorded. Thus, ink mist generated from the recording head during measurement is shielded by the sheet, and does not easily reach the direct sensor side, and therefore deterioration in performance due to adhesion of ink to the light source, light receiving element, and window of the direct sensor can be suppressed.

In addition, the direct sensor is fixedly provided in the vicinity of the recording position, so that it can always detect the sheet condition without being affected by the carriage moving condition, and the position, size, etc. of the sheet. In all of the examples illustrated in FIGS. 5A and 5B and FIGS. 6A and 6B, the direct sensor is provided in the vicinity of the center of the recording region in the x-direction.

Irrespective of the size of the sheet to be used (the sheet width in the x-direction), the center of the sheet in the x-direction passes by the measurement position of the direct sensor. Thus, even if the size of the sheet is small, it is possible to measure the sheet condition by the direct sensor.

In addition, irrespective of the sheet size, the direct sensor measures the portion of the sheet in the vicinity of the center thereof, so that even if skew feeding or meandering is generated during sheet conveyance, it is possible to perform measurement without being greatly affected thereby.

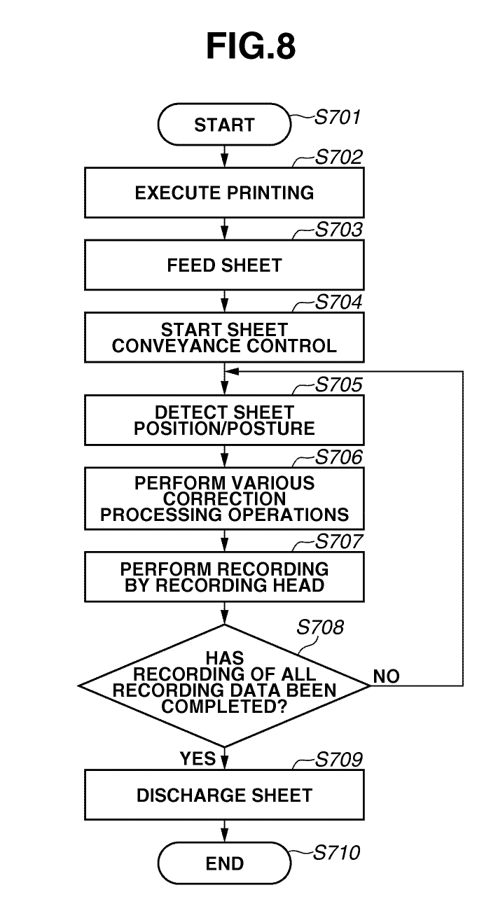

Next, a sheet condition detection sequence using the direct sensor of the printer of the present exemplary embodiment will be described with reference to the flowchart of FIG. 8.

When, in step S701, the sequence is started, and a printing execution command is issued in step S702. In step S703, the sheet is fed to the recording unit by the feed roller. In step S704, sheet conveyance control for image recording operation is started. In the case of the serial printer of FIGS. 5A and 5B, the sheet is fed stepwise by a predetermined amount at a time.

The predetermined amount corresponds to the length in sub scanning direction in 1-band recording (one main scanning of the recording head). For example, in a case where multi-path recording is conducted through double superimposition while feeding half the nozzle row width in the y-direction of the recording head 305 at one time, the predetermined amount is half the nozzle row width. In the case of the line printer of FIGS. 5A and 5B, the sheet is continuously fed at a fixed speed.

During image recording operation, the direct sensor detects the sheet moving condition in the y-direction. Regarding the y-direction, the control unit controls the motor drive while monitoring the rotating condition of the conveyance roller using the rotary encoder. Feed back control (servo control) is performed so that the sheet may be moved by a predetermined amount (control target value).

Along with the conveyance control using the encoder, the sheet moving condition in the y-direction is detected by using the direct sensor. The direct sensor detects the sheet moving speed in real time. The control unit can obtain the moving distance by integrating the same.

The direct sensor directly performs measurement on the surface of the sheet, so that it can detect the moving condition with higher accuracy as compared with the encoder. Thus, the difference between the detection value of the encoder and the detection value of the direct sensor is to be regarded as an error component of the encoder.

In view of this, correction of error component is performed in the feedback control using the encoder. The correction may be performed by a method in which the current position information in conveyance control is increased or decreased by an amount corresponding to the error, or by a method in which the target conveyance amount is increased or decreased by an amount corresponding to the error.

In this way, through feedback control using both the encoder and the direct sensor, it is possible to perform with very high accuracy the sheet step feeding amount control (serial printer) or the sheet continuous feeding speed control (line printer).

In the present exemplary embodiment, the direct sensor measures the portion of the sheet in the vicinity of the center thereof irrespective of the sheet size. Thus, even if skew feeding or meandering is generated during sheet conveyance, it is possible to correct the conveyance amount without being greatly affected thereby.

In the case where skew feeding or meandering is generated, there is measured in the vicinity of the center of the sheet a value including the average error amount of the large conveyance error amounts at both ends of the sheet. By performing correction based on the measurement value obtained in the vicinity of the center, it is possible to perform correction of minimum error as a whole.

In step S705, by using the direct sensor, there is detected at least one of the position of the sheet in the z-direction, and the sheet posture (local inclination direction and inclination angle of the sheet with respect to a plane including the x-direction and y-direction). Based on this detection, the distance from an arbitrary nozzle position to the first surface of the sheet directly below the same is detected to thereby detect the position and posture of the sheet. A specific detection method will be described below.

In step S706, based on the information obtained in step S705, correction is performed in such a manner that an image is recorded at a position nearer to the target position on the sheet.

In the serial printer of FIGS. 5A and 5B, in the case where a change in distance is detected as in FIG. 1B, the ink imparting position is corrected as illustrated in FIGS. 2B and 2E, and in the case where a change in posture is detected as in FIG. 1C, the ink imparting position is corrected as illustrated in FIGS. 2C and 2F.

In the line printer of FIGS. 6A and 6B, in the case where a change in distance is detected as in FIG. 3B, the ink imparting position is corrected as illustrated in FIGS. 4B and 4E, and in the case where a change in posture is detected as in FIG. 3C, the ink imparting position is corrected as illustrated in FIGS. 4C and 4F. A specific correction method will be described below.

In step S707, an image is recorded by the recording head while performing the correction of step S706. In step S708, it is determined whether the recording of all the recording data has been completed or not. When it has not been completed (NO in step S708), the procedure returns to step S705 to repeat a similar operation. There are repeated step feeding through sub scanning and recording operation through scanning with the recording head. When the recording of all the data has been completed (YES in step S708), the procedure advances to step S709. In step S709, the sheet that has undergone recording is discharged from the printer by a discharge roller. In this way, a two-dimensional image is formed on the sheet, and the sequence is ended in step S710.

The direct sensor is capable of detecting the moving condition of the sheet not only in the y-direction but also in the x-direction.

In the sheet conveyance in the y-direction during image recording operation, the sheet may fail to be fed straight, a shift may occur in the x-direction due to skew feeding or meandering or unintended slippage or shock. It is desirable to correct such deviation in the x-direction component through detection of the movement with respect to the x-direction component by using the direct sensor.

In the serial printer of FIGS. 5A and 5B, 1-band recording is performed while deviating the recording timing of the recording head according to the deviation amount in the x-direction detected. In the line printer of FIGS. 6A and 6B, recording is performed while changing (shifting) the range of use of the linear nozzle row of the recording head according to the detected deviation amount in the x-direction.

Next, the method of detecting the position and posture of the sheet performed in step S705 in FIG. 8 will be described in detail.

As described above, the direct sensor performs detection by employing at least one of the function by which the sheet position in the z-direction is detected (function A), and the function by which the sheet position with respect to the xy-plane is detected (function B). Based on the information obtained from this detection, there is obtained the distance from an arbitrary nozzle position to the first sheet surface directly below the same.

According to whether the printer is a line printer or a serial printer and whether there is a platen or not, the following seven cases, i.e., cases (A1) through (A4) and cases (B1) through (B3) will be described below.

Case (A1): The Printer is a Serial Printer and in which There Exists a Platen (Function A is Employed).

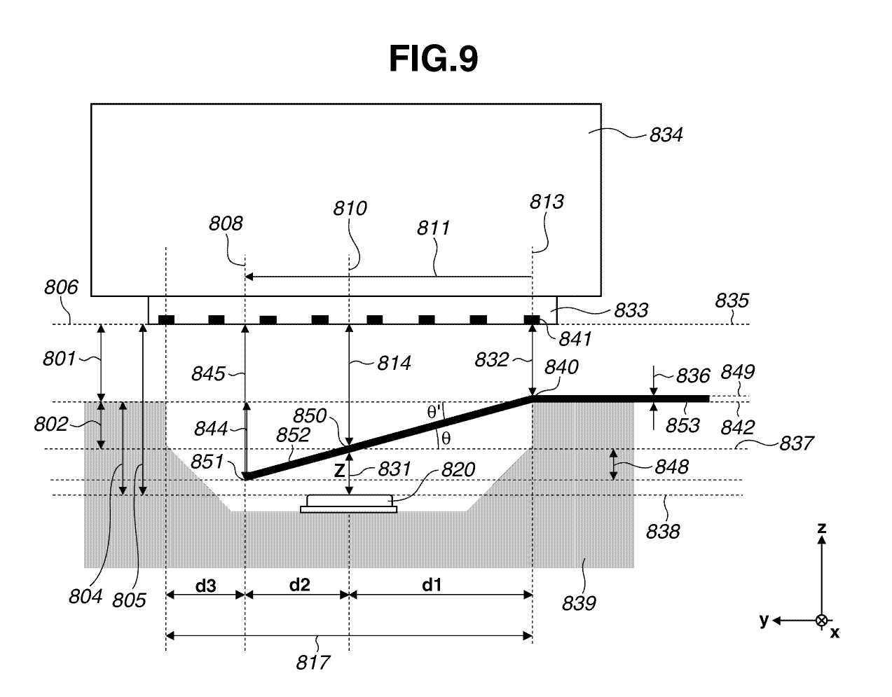

To be described will be a case in which, in a serial printer, a recording head 833 retained by a carriage 834 and the leading edge of a sheet 852 are in the relationship as illustrated in FIG. 9.

In a case where there exists a platen 839 supporting a sheet 853 from below at the recording position, there exists at an end portion of the platen support surface a positional reference 840 serving as a reference for the sheet height position. When the positional reference 840 exists, it is possible to estimate the sheet posture with relatively high accuracy.

In the example, the distance 832 in the ideal condition between “the position 835 in the z-direction of a nozzle 841” and “the position 849 in the z-direction of the first sheet surface” is 1000 μm. The width in the y-direction of the recess of the platen 839, in which a direct sensor 820 is embedded, is indicated by a distance 817. In the recess, the direct sensor 820 is provided at the central position in the y-direction (where the distance to the end portion is d1).

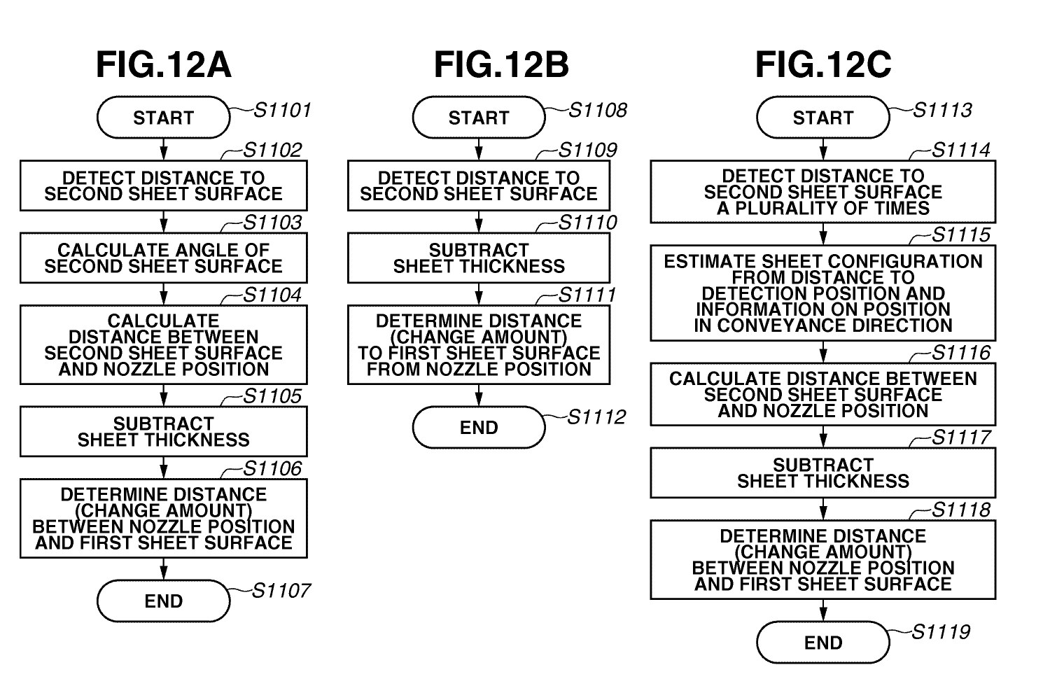

FIG. 12A is a flowchart illustrating the detection sequence. In step S1101, the sequence is started. In step S1102, there is detected, by the direct sensor 820, the distance 831 in the z-direction between the direct sensor and the second surface of the sheet at rest.

It is also possible to perform the detection a plurality of times, while the conveyance is stopped, to obtain an average value, thereby suppressing variation in detection. The distance 831 is the distance between “a position 838 in the z-direction of the direct sensor surface” and “a position 837 in the z-direction of the second sheet surface at a measurement position 850” (which, in this example, is 1000 μm).

In step S1103, the sheet inclination angle θ with respect to the direct sensor using the xy-reference plane as the reference is obtained from the following equation 1:

θ=arctan (distance 802/distance 819) (1)

Here, the distance 802 is the distance between “the position 842 in the z-direction of the positional reference 840” and “the position 837 in the z-direction of the second sheet surface at the measurement position”.

The position 837 in the z-direction of the second sheet surface at the measurement position is calculated by subtracting the distance 831 from the distance 804 between “the position 842 in the z-direction of the positional reference 840” and “the position 838 in the z-direction of the direct sensor surface” (which, in this example, is 1250 μm). The distance 819 is the distance between “the position 813 in the y-direction of the positional reference 840” and “the position 810 in the y-direction at the measurement position” (which, in this example, is 12700 μm). The angle θ is obtained as follows: θ=arctan ((1250 μm−1000 μm)/(12700 μm)=1.13 [deg].

In step S1104, the distance 845 in the z-direction between a position in the z-direction at an arbitrary position in the y-direction of the recording head surface and the second sheet surface directly below the same (zₓ₋ₛ₂), is obtained from the following equation (2). In this example, the arbitrary position in the y-direction is the position 808 in the y-direction of the sheet leading edge portion 851.

z_{x-S2}=the distance 801+the distance 844 (2)

Here, the distance 801 is the distance between “the position 835 in the z-direction of the recording head surface” and “the position 842 in the z-direction of the position determining place” (which, in this example, is 1100 μm).

The distance 844 corresponds to the change in sheet height (z_{x(θ)}) due to the sheet inclination at an arbitrary position in the y-direction directly below the recording head, and it is obtained by the following equation (3):

z_{x(θ)}=the distance 811×tan θ (3)

The distance 811 is the distance between “an arbitrary position 808 in the y-direction of the recording head surface” and “the position 813 in the y-direction at the position determining place” (which, in this example, 19957 μm).

Thus, z_{x(θ)} and zₓ₋ₛ₂ are calculated as follows:

z_{x(θ)}=19957 μm×tan 1.13°=394 μm

zₓ₋ₛ₂=1100 μm+394 μm=1494 μm

In step S1105, the thickness 836 of the sheet (100 μm in this example), which is the difference between the first surface 849 and the second surface 842 of the sheet, is subtracted. In step S1106, the distance 814 between the recording head at an arbitrary position in the y-direction and the first sheet surface is determined through calculation.

Here, the thickness information may be detected by providing the recording apparatus with a sensor for detecting sheet thickness, or the thickness information may be estimated at the control unit from information on the sheet to be used previously input to the apparatus by the user.

The distance between the recording head and the first sheet surface at an arbitrary position in the y-direction is obtained from the following equation (4):

Distance=zₓ₋ₛ₂−the sheet thickness 836 (4)

The sheet leading edge portion is calculated as follows: 1494 μm−100 μm=1394 μm. That is, it can be seen that, as a result of positional deviation due to the sheet inclination, the distance between the recording head surface and the sheet at the sheet leading edge portion is deviated far from the ideal distance by 394 μm. When the calculation is thus completed, the sequence is completed in step S1107.

In this way, it is possible to estimate the sheet inclination based on the distance detection in the z-direction by the direct sensor, and obtain the distance from the arbitrary x-th nozzle position in the y-direction to the first sheet surface directly below the same. This calculation method is only one example, and the present invention is not limited thereto.

The configuration of the sheet surface is not always linear, and may actually have a rounded shape. In this case, calculation is performed through curved line fitting or combination of the curved line fitting and straight line fitting based on the information on the measurement position 850 and the positional reference 840. If the tendency in change peculiar to the sheet surface configuration can be known, it is possible to reflect it as a parameter and perform calculation through combination.

Case (A2): The printer is a serial printer, and there exists no platen (function A is employed).

Another case where detection is effected by employing function A of the direct sensor will be described.

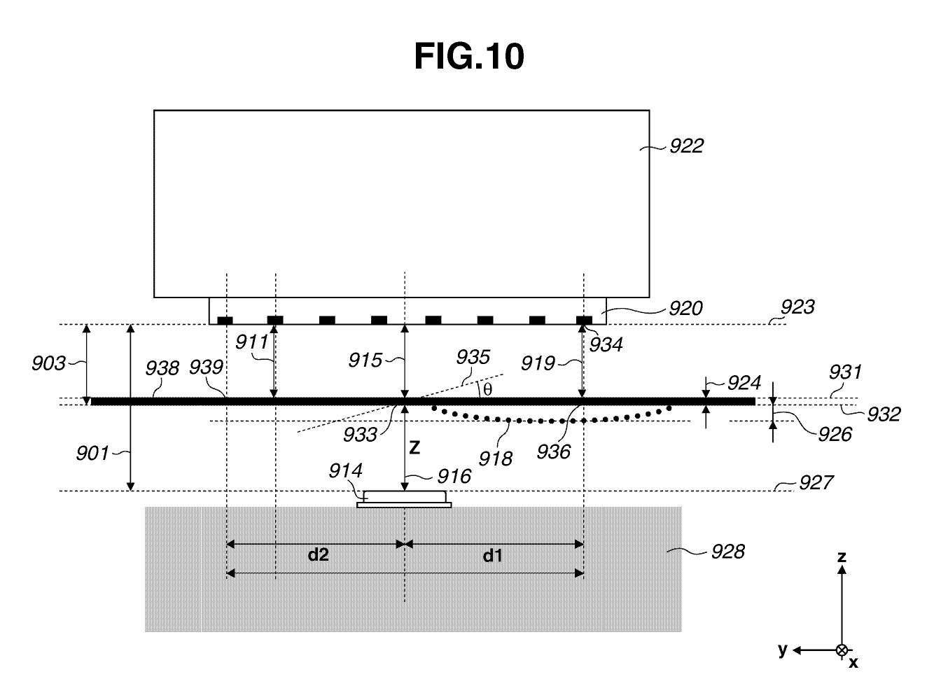

When there exists no platen in a serial printer, a recording head 920 held by a carriage 922 and a sheet 938 are in the relationship as illustrated in FIG. 10. Here, a case is assumed in which if the distance between the recording head and the sheet fluctuates, the difference in the distance between the upstream and downstream sides is relatively small.

A direct sensor 914 is provided on a base 928, which is not in contact with the sheet 938. In the y-direction, the direct sensor 914 is provided at the central position of the nozzle row of the recording head 920, and the distance d1=the distance d2.

In the present example, each of the distances 911, 915, and 919 between the “the position 923 in the z-direction of the nozzle 934” and “the position 931 in the z-direction of the first sheet surface” in the ideal state is 1000 μm. The sheet 938 may move vertically and wholly in the z-direction, or may move vertically and locally in the z-direction.

In the example of FIG. 10, a local portion 918 of the sheet slacks downwardly by a distance 926.

FIG. 12B is a flowchart illustrating a detection sequence. In step S1108, the sequence is started. In step S1109, the distance 916 in the z-direction between the direct sensor and the second surface 932 of the sheet at rest is detected by the direct sensor 914. It is also possible to perform the detection a plurality of times, while the conveyance is stopped, to obtain an average value, thereby suppressing variation in detection. The distance 916 is the distance between “the position 927 in the z-direction on the direct sensor surface” and “the position 933 in the z-direction of the second sheet surface at the measurement position 908” (which, in this example, is 1400 μm).

In step S1110, “the distance 903” and “the sheet thickness 924” (which, in this example, is 100 μm) are subtracted from the distance 901 between “the position 923 of the nozzle in the z-direction” and “the position 927 of the direct sensor surface in the z-direction” (which, in this example, is 2000 μm).

In step S1111, the distance 915 from the nozzle position to the first sheet surface 931 is calculated from the following equation (5). The method of obtaining the sheet thickness information is as described above.

The distance 915=the distance 901−the distance 916−the sheet thickness=2000 μm−1400 μm−100 μm=500 μm (5)

It can be seen that the sheet position is closer to the nozzle position by 500 μm, whereas the distance in the ideal state between “the position 923 in the z-direction of the nozzle 934” and “the position 931 in the z-direction of the first sheet surface”. When the calculation is thus completed, the sequence is ended in step S1112.

In this way, based on the detection of sheet inclination by the direct sensor, it is possible to obtain the distance from an arbitrary x-th nozzle position in the y-direction to the first sheet surface directly below the same.

It is possible to estimate the sheet posture by the above calculation method, obtain the distance from the nozzle position to the first sheet surface directly below the same. This calculation method is only an example, and the present invention is not limited thereto. For example, if the tendency in change peculiar to the sheet surface configuration is known, it is possible to reflect the same as a parameter, to perform calculation through combination.
Case (A3): The Printer is a Serial Printer, and there Exists a Platen (Function B is Employed).

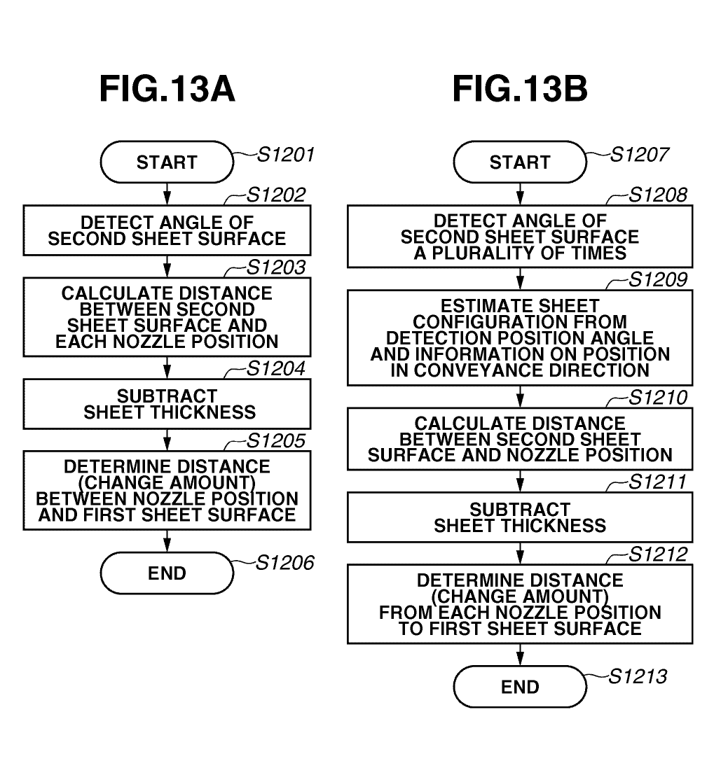

Another case in which detection is performed by using function B of the direct sensor will be illustrated. In the case of FIG. 9, in which the printer is a serial printer (with a platen existing), there is performed a detection sequence as illustrated in a flowchart of FIG. 13A.

In step S1201, the sequence is started. In step S1202, the direct sensor 820 detects, with respect to the sheet at rest, a local sheet inclination angle θ with respect to the direct sensor using the xy-plane as a reference (e.g., 1.13°).

In FIG. 12A, the angle θ is calculated in step S1103 by equation (1). In the present example, the angle is directly detected by using the direct sensor. It is also possible to perform the detection a plurality of times while the conveyance is not being performed to obtain an average value, thereby suppressing variation in detection.

Steps S1203 through S1205 are similar to steps S1104 through S1106 in FIG. 12A, so that duplicate description thereof will be omitted.

In this way, based on the detection of sheet inclination by the direct sensor, it is possible to obtain the distance from an arbitrary x-th nozzle position in the y-direction to the first sheet surface directly below the same.

Case (A4): The Printer is a Serial Printer, and there Exists a Platen (Function A and Function B are Employed).

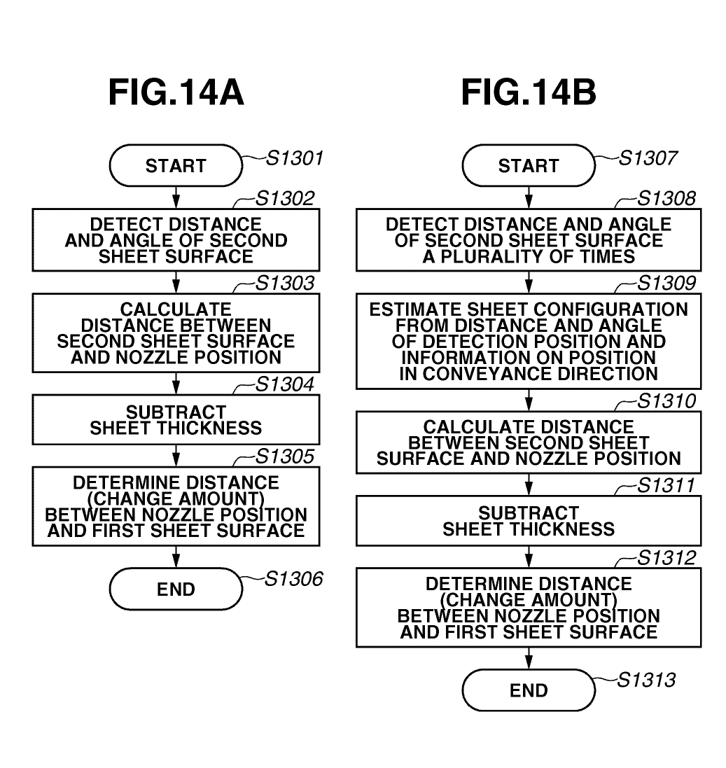

Another case in which detection is performed by using both function A and function B of the direct sensor will be described. In the case of FIG. 9, in which the printer is a serial printer (with a platen existing), the detection sequence as illustrated in a flowchart of FIG. 14A is performed.

In step S1302, the sequence is started. In step S1302, the distance 831 in the z-direction between the direct sensor and the second sheet surface is detected by the direct sensor 820, and a local sheet inclination angle θ with respect to the direct sensor using the xy-plane as a reference is detected. That is, by using a single direct sensor, both the distance in the z-direction and the sheet inclination angle are detected. It is also possible to perform the detection by the direct sensor a plurality of times while the conveyance is not being performed to obtain an average value, thereby suppressing variation in detection.

In step S1303, the distance 845 (zₓ₋ₛ₂) in the z-direction between a position in the z-direction at an arbitrary position in the y-direction of the recording head surface and the second sheet surface directly below the same, is obtained from the following equation (6).

zₓ₋₂=the distance 805−the distance 831+z_{x(θ)} (6)

Here, the distance 805 is the distance between “the position 835 in the z-direction of the nozzle” and “the position 838 in the z-direction on the direct sensor surface” (which, in this example, 2350 μm).

z_{x(θ)} corresponds to the fluctuation in the position in the z-direction due to sheet inclination from the measurement position in the z-direction directly below an arbitrary position in the y-direction of the recording head surface, and it is obtained from the following equation (7):

z_{x(θ)}=the distance d2×tan θ (7)

The distance d2 is the distance between “an arbitrary position 808 in the y-direction of the recording head surface” and “the position 810 in the y-direction of the second sheet surface at the measurement position 850”.

When the sheet is closer to the nozzle surface than the position in the z-direction at the measurement position 850, the sign is negative, and when the sheet is farther therefrom, the sign is positive. In the case where (0<θ<90), the sign affixed is negative when “the arbitrary position 808 in the y-direction on the recording head surface” is situated on the upstream side of “the position in the y-direction on the second sheet surface at the measurement position 850”, and the sign affixed is positive when calculation at the downstream side nozzle position is performed. On the other hand, in the case where (−90<θ<0), the sign affixed is reversed to that in the case where (0<θ<90). In the y-direction, the distance from the position of the distance d2 to the groove end portion is indicated as the distance d3. The distance d2+the distance d3=the distance d1.

In the present example, θ=1.13°, which means (0 θ<90), and “the arbitrary y-direction position 808 on the recording head surface” is on the downstream side of “the y-direction position 810 of the second sheet surface at the measurement position 850” (in this example, it is 7257 μm), so that the sign affixed is positive, and calculation is performed as follows:

z_{x(θ)}=+7257 μm×tan 1.13°=143 μm

zₓ₋ₛ₂=2350 μm−1000 μm+143 μm=1493 μm

Steps S1304 through S1305 are similar to steps S1105 through S1106 in FIG. 12A, so that a redundant illustration thereof will be omitted.

In this way, based on the sheet position in the z-direction and the sheet inclination detected by the direct sensor, it is possible to obtain the distance from the arbitrary x-th nozzle position in the y-direction to the first sheet surface directly below the same.

Case (B1): The printer is a line printer, and there exists no platen (Function A is employed).

Next, a case where the printer is a line printer will be described. In this case, the printer is a line printer, and the form of FIG. 10 is assumed (in which there exists no platen), with detection being performed by employing function A of the direct sensor, the detection sequence as illustrated in a flowchart of FIG. 12C is performed.

In FIG. 10, the recording head 920 is to be regarded as one in which there are arranged in the y-direction a plurality of line heads in which a large number of ink nozzles are arranged in the vertical direction as seen in the diagram. The sheet 938 may, for example, move vertically as a whole in the z-direction, or may make local vertical movement in the z-direction (portion 918).

In this example, the detection of the sheet by the direct sensor is performed a plurality of times during the sheet conveyance in the image recording operation. By repeating the detection while conveying the sheet, it is possible to acquire information regarding the configuration profile of the sheet having passed by the measurement position of the sensor.

In step S1113, the sequence is started. In step S1114, the direct sensor 914 repeatedly detects the distance 916, with respect to the sheet 938 continuously moving in the y-direction, in the z-direction between the direct sensor and the second surface 932 of the sheet 938.

In step S1115, the configuration profile is created from the detected sheet positions in the z-direction at the plurality of positions in the y-direction, thereby estimating the sheet configuration.

In step S1116, the distance to the second sheet surface positioned directly below the arbitrary x-th nozzle is obtained from the sheet conveyance amount and the sheet configuration profile created in step S1115. The present invention is not limited to the case of a line printer. Also in the case of a serial printer, it is possible to estimate the configuration of the sheet portion having passed by the measurement position.

Steps S1117 and S1118 are similar to steps S1105 and S1106 of FIG. 12A, so that duplicate description thereof will be omitted.

In this way, by repeating distance detection in the z-direction by the direct sensor while conveying the sheet, the sheet configuration profile is acquired. By using this profile, it is possible to more accurately detect the distance from an arbitrary line head to the sheet.

Regarding the portion of which the profile has been acquired, it is possible to more accurately perform a correction processing described below. In view of this, it is also possible to arrange the direct sensor more upstream so that the position where measurement is performed by the direct sensor is on the upstream side of the recording region of the recording head in the y-direction, and to acquire sheet profile information prior to the recording start.

Case (B2): The Printer is a Line Printer, and there Exists No Platen (Function B is Employed).

In the case where the printer is a line printer and where the form of FIG. 10 (in which no platen exists) is assumed, with detection being performed by using function B of the direct sensor, there is performed a detection sequence as illustrated in a flowchart of FIG. 13B.

In step S1207, the sequence is started. In step S1208, the direct sensor 914 repeats detection a plurality of times, with respect to the sheet 938 moving continuously in the y-direction, the local sheet inclination angle θ (indicated by numeral 935) with respect to the direct sensor using the xy-plane as a reference.

In step S1209, the sheet configuration profile is created from the local sheet inclination angles at the plurality of positions in the y-direction at which detection has been performed, thereby estimating the sheet configuration.

Steps S1210 through S1212 are similar to steps S1116 through S1118 of FIG. 12C, so that duplicate description thereof will be omitted.

Case (B3): The Printer is a Line Printer, and there Exists No Platen (Functions A and B are Employed)

In the case where the printer is a line printer and where the form of FIG. 10 (in which no platen exists) is assumed, with detection being performed by using both functions A and B of the direct printer, there is performed a detection sequence as illustrated in a flowchart of FIG. 14B.

In step S1307, the sequence is started. In step S1308, the direct sensor 914 repeatedly detects a plurality of times, with respect to the sheet 938 moving continuously in the y-direction, the distance 916 in the z-direction between the direct sensor and the second surface 932 of the sheet, and the local inclination angle θ at the measurement position.

In step S1209, the sheet configuration profile is created from the sheet position in the z-direction and the local sheet inclination angle at the plurality of positions in the y-direction of the detected sheet, and thereby the sheet configuration is estimated.

Steps S1310 through S1312 are similar to steps S1116 through S1118 of FIG. 12C, so that duplicate description thereof will be omitted.

In the above examples, it is possible to detect the sheet condition in the vicinity of the recording head without being affected by the carriage moving condition and the position, size, etc. of the sheet.

Next, the correction processing performed in step S706 of FIG. 8 will be described in detail. The correction method may be roughly classified into three types such as (1) a method in which the recording timing of the recording head is changed, (2) a method in which the sheet moving amount is changed, and (3) a method in which the range of use of the recording head is changed. In the following, each of the above three methods will be described.

(1) The Method in which the Recording Timing of the Recording Head is Changed:

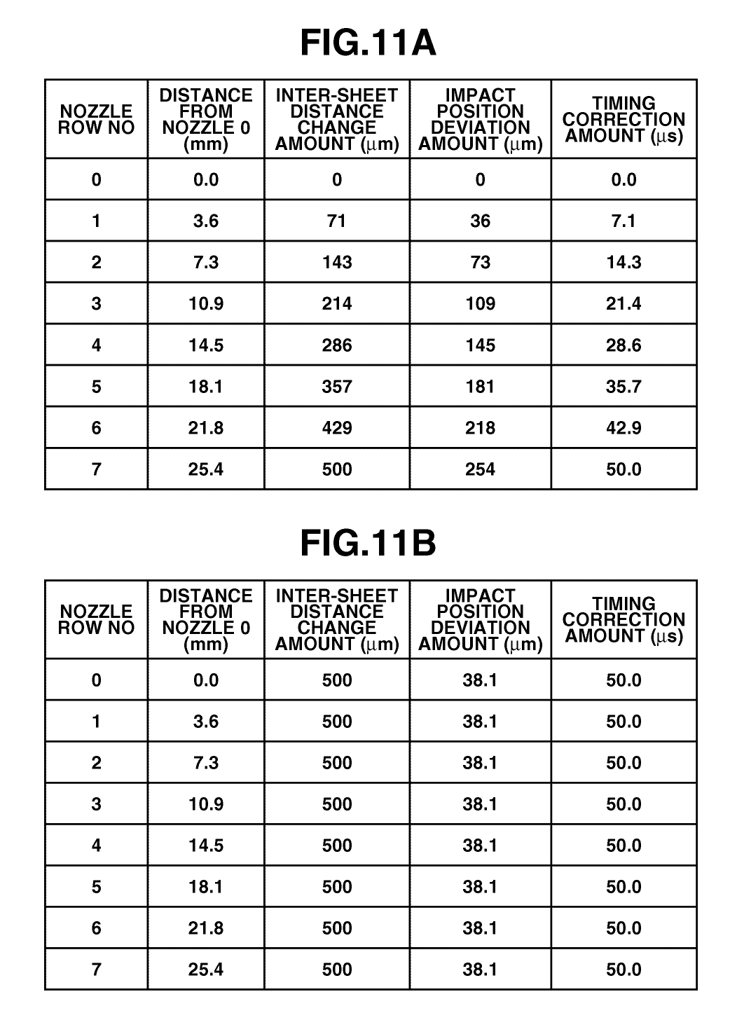

The data table of FIG. 11A shows information regarding each of the nozzle positions (nozzles Nos. 0 through 7) obtained through detection of sheet posture with respect to the recording head when the position and posture of the sheet are changed as illustrated in FIGS. 1A to 1C in the case of a serial printer. The data table of FIG. 11B shows information for each line head obtained when the position and posture of the sheet are changed as illustrated in FIGS. 3A to 3C in the case of a serial printer.

The items of information of the data table consist of the distance from the nozzle for each nozzle (mm), the distance change amount between the sheet and nozzle (μm), the impact position deviation amount (μm), and the discharge timing correction amount (μs).

For example, in the case of nozzle No. 7, which is positioned at a position shifted from the position of nozzle No. 0 by 25.4 mm, the change amount of the distance to the first surface of the sheet from the ideal position is 500 μm. The deviation amount of the impact position due to this change amount is, in the case where the flying speed of the ink discharged from the recording head is 10 m/s, the distance change amount for the nozzle No. 7 is 500 μm. That is, as compared with the ideal state, the requisite impact time is longer by 500 μm/(10 m/s)=50.0 μs.

Supposing that the moving direction of the recording head at the time of recording is the +x-direction, and that the moving speed thereof is 20 inch/sec, if ink is discharge in this state, the impact position will be deviated from the target position 122 in the x-direction by 50.0 μs×20 inch/sec=254 μm (distance 123).

To correct this deviation, the control unit refers to the data table, and expedites the discharge timing by 50.0 μs, which is given as the discharge timing correction amount for nozzle No. 7, whereby it is possible to cause the impact position in the x-direction to move closer to the ideal position 131 as illustrated in FIG. 2F.

The discharge timing for the nozzles other than nozzle No. 7 is also changed in a similar fashion, whereby it is possible to cause the ink to impinge upon the sheet at a position closer to the ideal impact position. Further, in the case in which, as illustrated in FIG. 1B, the sheet is fluctuated in the z-direction parallel to the nozzle, it is possible to cause all the impact positions to move closer to the ideal position through a similar correction.

As is known in the art, the ink discharged from the inkjet type ink nozzle contains main droplets and sub droplets (satellites) subsequent thereto, and the flying speed of the main droplets are different from that of the sub droplets. Thus, when the distance between the recording head and the sheet is changed, the distance between the impact position of the main droplets and that of the sub droplets is also changed.

In view of this, it is also possible to calculate the fluctuation in the distance between the main droplets and sub droplets due to the change in the distance between the recording head and the sheet, to correct the scanning speed (in the case of a serial printer) or the sheet conveyance speed (in the case of a line printer) so as to compensate for the change in distance. This makes it possible to suppress great deviation in impact position between the main and sub droplets.

(2) The Method in which the Sheet Moving Amount is Changed:

In a serial printer, by changing the sheet moving amount in one of the repeated sheet step feed operations, it is also possible to perform correction. Supposing that, for example, during the N-th recording head scanning, the sheet is inclined with respect to the recording head, and there is no sheet inclination with respect to the recording head during the (N
+1)th recording head scanning.

During the N-th recording head scanning, due to the inclination of the sheet, the impact positions spread wider than the ideal impact region in the y-direction. When the (N+1)th recording is performed on the sheet which has been recorded in this state after the stepwise feed by a predetermined amount, the upstream side nozzle impact position recorded through the N-th recording head scanning and the downstream side nozzle impact position recorded through the (N+1)th recording head scanning overlap partly each other.

At the overlapping position, the image density increases, resulting in an image streak. In view of this, the image width increase is estimated based on the sheet posture detection during the N-th recording, increasing the sheet moving amount in the next stepwise feed by an amount corresponding to the width increase with respect to a predetermined amount. As a result, it is possible to avoid dot impact overlapping through the N-th and (N+1)th recording, making it possible to suppress generation of image streak.

(3) The Method in which the Range of Use of the Recording Head is Changed:

In the above method (2), by changing the region used for image recording by the recording head (the nozzles to be used) instead of changing the sheet moving amount in the stepwise feed, it is also possible to perform correction.

In the case of the above example, the image width to be increased is estimated based on the sheet posture detection during the N-th recording, and the range of use for the nozzles of the recording head during the N-th recording is restricted so that there may be generated no impact overlapping during the (N+1)th recording head scanning. More specifically, adjustment is made by not using the nozzles on the upstream side.

The image data to have been recorded by the nozzles not used is carried forward to the recording by the (N+1)th recording head scanning after the conveyance by a predetermined amount. As a result, it is possible to void dot impact overlapping due to the N-th and the (N+1)th recording, thus making it possible to suppress generation of an image streak.

The above correction methods (1) through (3) may be combined with each other as desired. For example, it is also possible to correct impact position deviation in both the x- and y-directions by combining the correction of the impact position in the x-direction through the recording timing correction by the above method (1) with the correction of the impact position in the y-direction through the sheet moving amount correction by the above method (2).

When the output value of the inclination information or distance information detected by the direct sensor exceeds a permissible range, it is desirable not to perform the above-described correction control. The direct sensor has a detection optical system as illustrated in FIGS. 7A and 7B, and the range of the distance to the object of measurement or of inclination that can be detected with satisfactory accuracy is mainly determined by the restrictions on the optical system.

Performing measurement in a state in which the range has been exceeded results in significant deterioration in detection accuracy. In view of this, the control unit previously sets the permissible range of the detection output value guaranteeing satisfactory detection accuracy, and does not perform the above-described correction processing when a detection value exceeding the permissible range is output.

Other than the correction of deviation in impact position, the information on the distance between the recording head and the sheet detected by the above-described direct sensor can also be used to control the apparatus operation. Some examples of the apparatus operation control will be described below.

### Example 1

### Avoidance of Contact Between the Recording Head and the Sheet

When the configuration and posture of the sheet have changed significantly, there is a possibility of the sheet coming into contact with the recording head to cause jamming in sheet conveyance and sheet soiling. To avoid this, when it is determined that the configuration or posture of the sheet has exceeded the permissible range based on the detection result of the direct sensor, the control unit performs control so as to execute at least one of the following operations.

1. Issuing a printing stop command to interrupt the recording operation, and discharging the sheet that being processed.
2. Temporarily stopping the recording operation or reducing the speed of the recording operation (the carriage moving speed or the sheet continuous feeding speed). A reduction in speed may also be achieved by increasing the waiting time between a certain scanning with the carriage and the next scanning.
3. Enlarge the distance between the recording head and the sheet. It is possible to enlarge the distance between the recording head and the sheet by moving (retracting) the recording head away from the sheet or by moving the sheet away from the recording head.
4. Suppressing rising of the sheet due to curling by restricting the amount of ink imparted. More specifically, the nozzle use range of the recording head is restricted, thereby restricting the amount of ink imparted to suppress sheet deformation. Alternatively, the number of bands in serial printing is increased to restrict the amount of ink imparted for 1-band recording.
5. Informing the user of generation of jamming or anything likely to cause deterioration in image quality through indication by an indicator of the control unit.

### Example 2

### Optimization of Calibration Processing

There is known a method in which a calibration pattern is recorded on a sheet by using a recording head and the recorded pattern is inspected to perform various calibrations related to the recording head. For the correction of this calibration processing, it is also possible to suitably utilize information on the distance between the recording head and the sheet detected by using the direct sensor.

If the distance between the recording head and the sheet when the calibration pattern is formed is different from that when image recording is performed, the calibration effect is reduced. That is because adjustment is made so that the optimum impact position is obtained with the distance when the calibration is performed.

Of the various calibration processing operations, the bidirectional registration adjustment for adjusting the ink impact position when the recording head of a serial printer reciprocates is greatly affected in terms of calibration accuracy by the fluctuation in the distance between the recording head and the sheet.

To avoid this, the control unit forms a calibration pattern at a position where measurement by the direct sensor is possible, and information on the distance between the recording head and the sheet at the time of the formation of the calibration pattern is measured by the direct sensor and stored. And, also at the time of image recording, the distance between the recording head and the sheet is measured by the direct sensor, and when there is a difference between the distance measured and the stored information, the correction in the calibration is performed so as to reduce the influence of the difference on the calibration. More specifically, the calibration value is corrected according to the difference.

In the recording apparatus described above, by using the direct sensor provided on the sheet second surface side, it is possible to detect the sheet condition in the vicinity of the recording head without being affected by the carriage moving condition and the position, size of the sheet. Various apparatus operations are controlled based on the detection of this direct sensor, so that it is possible to record an image of high quality.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-226584 filed Oct. 6, 2010, which is hereby incorporated by reference herein in its entirety.

What is claimed is:

1. A recording apparatus comprising:
a recording head configured to record an image on a first surface of a moving sheet;
a sensor arranged so as to face a second surface of the moving sheet on the back side of the first surface thereof and configured to perform measurement on the second surface at a measurement position to thereby detect at least one of information on sheet inclination at the measurement position and positional information on a sheet position in a direction of a distance between the recording head and the sheet at the measurement position; and
a control unit configured to control an operation of the recording apparatus based on the detection by the sensor.

2. The recording apparatus according to claim 1, wherein the sensor further detects the sheet moving state in at least one of a first direction in which the sheet moves and a second direction crossing the first direction in a sheet plane.

3. The recording apparatus according to claim 1, wherein the control unit performs correction control of the recording by the recording head as the operation of the recording apparatus based on the measurement by the sensor.

4. The recording apparatus according to claim 3, wherein the control unit performs correction control so as to change the recording timing of the recording head, the range of use of the recording head, or the moving amount of the sheet based on the measurement by the sensor.

5. The recording apparatus according to claim 3, wherein when the inclination information or the positional information exceeds a permissible range, the control unit does not perform the correction control.

6. The recording apparatus according to claim 1, wherein the control unit performs control of the operation of the recording apparatus by further using information related to a thickness of the sheet.

7. The recording apparatus according to claim 1, wherein the control unit estimates a sheet configuration based on the result of measurement by the sensor repeated a plurality of times when the sheet passes the measurement position, and performs control of the operation of the recording apparatus based on the estimation.

8. The recording apparatus according to claim 7, wherein when a region including an end portion of the sheet passes through the measurement position, the control unit estimates the configuration of the sheet region including the region based on the result of measurement repeated a plurality of times by the sensor.

9. The recording apparatus according to claim 1, wherein the measurement position is a position in the vicinity of the center of a region where the recording head can perform recording.

10. The recording apparatus according to claim 1, wherein the measurement position is a position within the region where the recording head performs recording or a position on the upstream side of the position in the direction in which the sheet moves.

11. The recording apparatus according to claim 1, wherein, based on the measurement by the sensor, the control unit performs control so as to execute as the apparatus operation at least one of the following: (1) interruption of the recording operation, (2) temporary stopping or decelerating of the recording operation, (3) increasing of the distance between the recording head and the sheet, (4) restriction of the amount of ink imparted, and (5) making the user informed.

12. The recording apparatus according to claim 1, wherein, based on the measurement by the sensor, the control unit performs, as the operation of the recording apparatus, correction in a calibration processing.

13. The recording apparatus according to claim 1, wherein the sensor includes a plurality of light sources and light receiving elements, and wherein irradiation light beams from the plurality of light sources are applied to the second surface from different directions, with the irradiation light beams scattered at the second surface and received by the plurality of light receiving elements.

14. The recording apparatus according to claim 13, wherein the sensor is equipped with a plurality of modules each having one of a group of light sources and one of a group of the light receiving elements, and
wherein irradiation light from the light source contained in a certain module and scattered light generated through scattering at the second surface and returning toward the certain module interfere with each other, with the intensity of the interference light being detected by the light receiving element contained by the certain module.

15. The recording apparatus according to claim 1, further comprising a platen for supporting the second surface of the moving sheet, wherein the platen has a recess at a position corresponding to the recording position recording by the recording head, with the sensor being provided in the recess.

16. The recording apparatus according to claim 1, further comprising a carriage configured to reciprocate in a second direction crossing a first direction in which the sheet moves, with an image being formed through alternate repetition of stepwise movement of the sheet and movement of the carriage,
wherein the measurement position is a position within the range of the reciprocal movement in the second direction.

17. The recording apparatus according to claim 1, wherein the recording head is a line type head on which recording elements are formed in a range covering the width of the sheet to be used in a second direction crossing a first direction in which the sheet moves, with an image being formed through recording by the recording head while moving the sheet,
wherein the measurement position is a position within the range in the second direction.

18. The recording apparatus according to claim 1, wherein the recording head discharges ink by an inkjet system.

19. A method of using a sensor capable of detecting local sheet inclination in a non-contact manner, wherein the sensor is arranged so as to face a second surface of a sheet on the back surface side of a first surface of the sheet on which an image is formed, the method comprising:
measuring the second surface at a measurement position to obtain information on sheet inclination at the measurement position; and
controlling an image recording operation based on the obtained information.
